(19) United States
(12) Patent Application Publication
(10) Pub. No.: US 2026/0101248 A1
(43) Pub. Date: Apr. 9, 2026

(54) SYSTEMS AND METHODS FOR AI/ML-BASED HANDOVER THRESHOLDS FOR HETEROGENEOUS WIRELESS NETWORKS

(71) Applicant: Verizon Patent and Licensing Inc., Basking Ridge, NJ (US)

(72) Inventors: Nimalan Kanagasabai, Grapevine, TX (US); Amir Saghir, Frisco, TX (US); Said Hanbaly, Prosper, TX (US); Mun Wei Low, Irving, TX (US); Rachel Y. Ward, Lewisville, TX (US)

(73) Assignee: Verizon Patent and Licensing Inc., Basking Ridge, NJ (US)

(21) Appl. No.: 18/905,909

(22) Filed: Oct. 3, 2024

(51) Int. Cl. H04W 36/00

(52) U.S. Cl. CPC H04W 36/00838; H04W 36/00725

(57) ABSTRACT

A system described herein may maintain models that associate inputs such as handover source information, handover target information, and User Equipment (“UE”) information, with outputs such as handover thresholds. The models may be generated based on handover interruption metrics associated with a plurality of handovers performed with respect to one or more UEs that are associated with the particular UE information. The system may receive a request for handover threshold information, and may select the particular model, where selecting the particular model includes determining that the request is associated with handover source information, handover target information, and UE information associated with the particular model. The system may output, in response to the request, handover threshold information associated with the particular model. A particular UE may use the set of handover thresholds to determine whether to perform a handover from a particular handover source to a particular candidate handover target.

### BACKGROUND

Wireless networks provide wireless connectivity to User Equipment (“UEs”), such as mobile telephones, tablets, Internet of Things (“IoT”) devices, Machine-to-Machine (“M2M”) devices, automated guided vehicles (“AGVs”), or the like. Wireless networks may provide access via different frequency bands or radio access technologies (“RATs”), such as Fifth Generation (“5G”) RATs, Long-Term Evolution (“LTE”) RATs, Wi-Fi RATs, and so on. A network that incorporates multiple different types of frequency bands or RATs may be referred to as a heterogeneous wireless network. In some examples, a wireless network may include Fixed Wireless Access (“FWA”) devices that connect to a wireless network using one RAT (e.g., a 5G RAT or an LTE RAT), and which serve as a wireless access point (e.g., implement a local wireless network) using a different RAT, such as a Wi-Fi RAT. Some UEs may be able to connect using multiple RATs, such as connecting to a base station of the wireless network using a 5G or LTE RAT, and connecting to an FWA device using a Wi-Fi RAT.

### BRIEF DESCRIPTION OF THE DRAWINGS

FIG. 1 illustrates an example overview of one or more embodiments described herein;

FIG. 2 illustrates an example of monitoring a wireless network for granular handover metrics, in accordance with some embodiments;

FIG. 3 illustrates example handover model information which may be used to determine handover thresholds, in accordance with some embodiments;

FIG. 4 illustrates an example process for dynamically determining handover thresholds for a given handover scenario, in accordance with some embodiments;

FIGS. 5 and 6 illustrate example environments in which one or more embodiments, described herein, may be implemented;

FIG. 7 illustrates an example arrangement of a radio access network (“RAN”), in accordance with some embodiments;

FIG. 8 illustrates an example arrangement of an Open RAN (“O-RAN”) environment in which one or more embodiments, described herein, may be implemented; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

A wireless network, such as a heterogeneous wireless network, may incorporate multiple types of RATs in order to provide wireless connectivity to UEs such as mobile telephones, IoT devices, M2M devices, AGVs, or the like. For example, a wireless network may utilize base stations such as evolved Node Bs (“eNBs”) or Next Generation Node Bs (“gNBs”) to implement longer range, higher capacity RATs such as 5G RATs or LTE RATs, and may utilize devices such as FWA devices, microcells, etc. that implement shorter range RATs such as a Wi-Fi RAT. In one example scenario, an FWA device may be deployed in an office or a warehouse in order to provide wireless connectivity to devices located within the office or warehouse, such as laptop computers, tablets, IoT devices, or the like, which do not necessarily include circuitry or otherwise have the capability of communicating via a 5G or LTE RAT. For example, the FWA device may implement the 5G or LTE RAT in order to connect to a Wide Area Network (“WAN”) such as the Internet, and devices that connect to the FWA device may communicate with the WAN via a Wireless Local Area Network (“WLAN”) implemented by the FWA device using a Wi-Fi RAT.

Handover scenarios may arise, in which a UE should be handed over from one type of wireless network access point to another (e.g., from a base station to a FWA device, or vice versa). For example, the UE may be moved into a building in which an FWA device is deployed, and may thus receive higher signal strength from the FWA device than from a base station to which the UE was connected prior to entering the building. As another example, a particular FWA device to which a UE is connected may become congested, and connecting to a base station may be more conducive to providing appropriate levels of performance, Quality of Service (“QoS”), etc. to the UE.

The UE and/or the network may make use of handover thresholds when determining whether to hand over the UE from one type of wireless network access point to another. For example, an example set of handover thresholds may specify that if a measure of signal strength and/or quality (e.g., Signal-to-Interference-and-Noise-Ratio (“SINR”), Received Signal Strength Indicator (“RSSI”), Reference Signal Received Power (“RSRP”), Reference Signal Received Quality (“RSRQ”), Channel Quality Indicator (“CQI”), or the like) of a network to which the UE is currently connected falls below a first threshold, and further if a candidate network to which the UE can potentially connect is above a second threshold, then the UE should be handed over to the candidate network. As such, a given set of handover thresholds may be variable in terms of both (a) the threshold of signal strength or quality for the wireless network access point to which the UE is currently connected, and (b) the threshold of signal strength or quality for the candidate wireless network access point to which the UE may potentially be handed over.

The effects of these thresholds may be crucial in providing an acceptable level of QoS to UEs, and setting the thresholds in an optimal manner may reduce any disruptions or performance degradations that may result from performing a handover. For example, if thresholds are too conservative (e.g., too low of a threshold of signal strength or quality for the wireless network access point to which the UE is currently connected and/or too high of a threshold of signal strength or quality for the candidate wireless network access point), a UE may tend to be handed over less frequently, which may result in degradations of performance resulting from remaining connected to a wireless network access point via which the UE may be measuring relatively low signal strength. On the other hand, if thresholds are too loose (e.g., too high of a threshold of signal strength or quality for the wireless network access point to which the UE is currently connected and/or too low of a threshold of signal strength or quality for the candidate wireless network access point), the UE may tend to be handed over more frequently, potentially back and forth (also referred to as “ping ponging”). Additionally, the actual handover procedure may result in a performance degradation, such as latency or packet loss that may result from handing over from one wireless network access point to another. As such, setting optimal handover thresholds may mitigate or eliminate the above concerns, thus resulting in an optimal QoS and user experience for UEs that connect to heterogeneous networks.

However, setting such thresholds manually may be unfeasible or impossible, due to widely varying characteristics, usage, and environments in which base stations, FWA devices, WLAN access points (“APs”), microcells, etc. are deployed. For example, a set of handover thresholds that are appropriate in one setting (e.g., in one building, in one facility, etc.) may be inapplicable in another setting (e.g., may cause too few handovers, may cause excessive handovers, etc.) due to the characteristics of such settings. Embodiments described herein may automatically determine and implement specific handover thresholds for specific wireless network access points (e.g., pairs of wireless network access points including a source and a target), that are precisely determined in order to provide optimal handover performance in a given deployment setting. In some embodiments, automated techniques such as artificial intelligence/machine learning (“AI/ML”) techniques may be used to continually refine the handover thresholds that are implemented in a given setting or time of day. As such, handover thresholds may be tailored to the specific characteristics of a given environment, setting, and/or pair of wireless network access points.

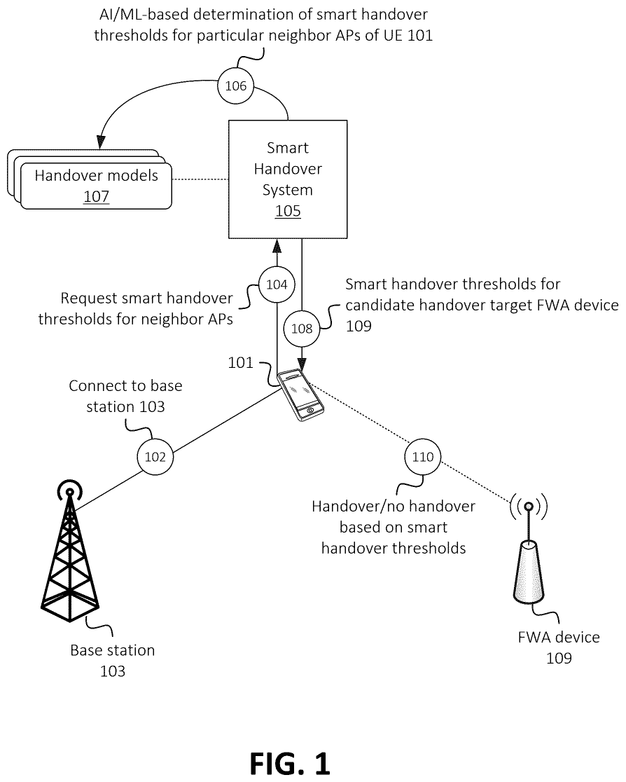

As shown in FIG. 1, for example, a particular UE 101 may connect (at 102) to base station 103. As noted above, base station 103 may be, may include, may implement, etc. a gNB, an eNB, etc. (e.g., that implements a first RAT, such as a 5G RAT or an LTE RAT). Base station 103 may be a part of a RAN of a wireless network, and may provide connectivity to one or more other networks such as a core of the wireless network, a WAN such as the Internet, etc. At some point while UE 101 is connected to base station 103, and in accordance with some embodiments, UE 101 may detect a potential handover scenario. For example, UE 101 may identify that signal strength and/or quality metrics, of the connection between base station 103 and UE 101, are below one or more thresholds. As another example, UE 101 may identify that performance metrics, such as latency and/or throughput, are below one or more thresholds. In some embodiments, UE 101 may identify the handover scenario in some other suitable manner.

UE 101 may output (at 104) a request for smart handover thresholds for neighbor APs. For example, UE 101 may output the request based on detecting a potential handover scenario, may output the request on a periodic basis or other ongoing basis, and/or may output the request based on some other triggering event. In some embodiments, UE 101 may implement an application programming interface (“API”), a software development kit (“SDK”), an application (e.g., an “rApp” in accordance with an O-RAN Alliance rApp standard), and/or some other communication pathway by which UE 101 outputs the request. In accordance with some embodiments, the request may include a request for handover thresholds that UE 101 may use to determine whether to request a handover from base station 103 to one or more other wireless network access points.

In some embodiments, the request may include additional information such as an identifier of UE 101 (e.g., an International Mobile Station Equipment Identity (“IMEI”) value, an International Mobile Subscriber Identity (“IMSI”) value, a Subscription Permanent Identifier (“SUPI”), a Globally Unique Temporary Identifier (“GUTI”), etc.) and/or attribute information of UE 101 (e.g., a make and/or model of UE 101, an operating system and/or operating system version of UE 101, battery level of UE 101, etc.). In some embodiments, the request may include an identifier of base station 103, such as a cell identifier, a base station identifier, or the like. In some embodiments, Smart Handover System (“SHS”) 105 may obtain additional UE information associated with UE 101 from a UE information repository associated with the wireless network (e.g., a Home Subscriber Server (“HSS”), a Unified Data Management function (“UDM”), a Unified Data Repository (“UDR”), etc.).

In some embodiments, UE 101 may output the request to SHS 105, which may be, may include, may be implemented by, etc. an application server, a network controller, or the like. In some embodiments, SHS 105 may implement an API, an SDK, an application, and/or some other communication pathway by which SHS 105 is able to communicate with UE 101. In accordance with some embodiments, SHS 105 may maintain or receive one or more handover models 107 that SHS 105 may use to determine smart handover thresholds for UE 101 in response to the request.

As discussed below, handover models 107 may be generated, trained, refined, etc. based on historical information associated with handovers performed with one or more wireless network access points (e.g., one or more base stations 103 and/or one or more FWA devices 109) as the sources and/or targets of handovers performed with respect to one or more UEs 101. The historical information may include attributes or characteristics associated with previously performed handovers, such as UE attribute information, handover source and/or target, performance metrics that reflect potential disruptions caused by handovers, and/or other suitable information.

Handover models 107 may accordingly be used to determine sets of handover thresholds for UEs 101 in various scenarios (e.g., when connected to a particular base station 103 and within communication range of one or more FWA devices 109, and/or when connected to a particular FWA device 109 and within communication range of one or more base stations 103 and/or FWA devices 109). For example, different handover models 107 may associate different sets of handover thresholds with different sets of input parameters such as UE attribute information, handover source and/or target, performance metrics, etc. In some embodiments, handover model 107 may include weights, factors, operations, or other information based on which respective sets of handover thresholds may be computed based on different sets of input parameters.

SHS 105 may identify that a particular FWA device 109 is a candidate access point to which UE 101 may potentially be handed over. For example, SHS 105 may maintain information associating FWA device 109 as a “neighbor” of base station 103. Additionally, or alternatively, handover models 107 may include one or more handover models 107 that are each associated with the particular base station 103 and FWA device 109 (e.g., one or more handover models 107 that are based on historical information for handovers to FWA device 109 from base station 103 and/or from FWA device 109 to base station 103). In some embodiments, UE 101 may indicate to SHS 105 that UE 101 has detected wireless signals (e.g., broadcasts, beacons, control messages, etc.) from FWA device 109. In some embodiments, SHS 105 may identify that FWA device 109 is a handover candidate for UE 101 based on other suitable information.

SHS 105 may, based on determining that UE 101 is connected to base station 103, and further based on determining that FWA device 109 is a potential handover candidate for UE 101, identify one or more particular handover models 107 that are associated with handovers between base station 103 and FWA device 109. In this example, base station 103 is a handover source for UE 101 and FWA device 109 is a potential handover target. Accordingly, in some embodiments, SHS 105 may identify one or more handover models 107 that are associated with handovers with the particular base station 103 as a handover source and the particular FWA device 109 as a handover target (e.g., excluding handover models 107 that are associated with handovers where base station 103 is the target and FWA device 109 is the source). Alternatively, in some embodiments, SHS 105 may identify one or more handover models 107 that are associated with any handovers between base station 103 and FWA device 109 (e.g., with either base station 103 or FWA device 109 being the source or target).

Additionally, or alternatively, SHS 105 may identify one or more handover models 107 based on information in addition to, or in lieu of, the source and/or candidate handover target(s) for UE 101. For example, SHS 105 may identify one or more models 107 that are associated with the same or similar attributes of UE 101 (e.g., the same make or model, the same operating system, etc.), with a time of day or day of week at which UE 101 may be handed over from base station 103 to FWA device 109, with a congestion state associated with base station 103 and/or FWA device 109, and/or other suitable information. As noted above, SHS 105 may determine (at 106) a set of handover thresholds for UE 101 using the identified handover model(s) 107.

SHS 105 may provide (at 108) the determined set of handover thresholds to UE 101 (e.g., via an API, SDK, application(s), etc. implemented at SHS 105 and/or UE 101). In some embodiments, SHS 105 may provide the determined set of handover thresholds to other elements of the wireless network, such as to base station 103 and/or FWA device 109. UE 101 may use the set of handover thresholds to determine (at 110) whether to request, initiate, perform, etc. (or whether to forgo requesting, initiating, or performing) a handover from base station 103 to FWA device 109. For example, as discussed above, the set of handover thresholds may indicate a first threshold signal strength or quality value for wireless signals between UE 101 and base station 103, where if the signal strength or quality between UE 101 and base station 103 is below the first threshold signal strength or quality, then the first threshold is satisfied. Additionally, the set of handover thresholds may indicate a second threshold signal strength or quality value for wireless signals between UE 101 and FWA device 109, where if the signal strength or quality between UE 101 and FWA device 109 is above the second threshold signal strength or quality, then the second threshold is satisfied. In some embodiments, in situations where both thresholds are satisfied, UE 101 may request, initiate, perform, etc. a handover from base station 103 to FWA device 109, in order to potentially receive improved wireless connectivity.

In some scenarios, the RATs implemented by the handover source and target may be different. For example, as discussed above, the handover source may implement a first RAT such as a 5G RAT or an LTE RAT, and the handover target may implement a second RAT such as a Wi-Fi RAT. On the other hand, the handover target may implement a 5G or LTE RAT and the handover source may implement a Wi-Fi RAT. As such, a respective set of handover thresholds may include different types of thresholds (e.g., different types of signal strength or quality metrics that are used in the context of the different RATs), and/or may be on different scales of magnitude by virtue of measuring characteristics of different RATs.

Examples are described herein in the context of UE 101 performing (or determining whether to perform) a handover from base station 103 to FWA device 109. In practice, similar concepts may apply in situations where UE 101 performs (or determines whether to perform) a handover from a given FWA device 109 to a given base station 103 or to another FWA device 109.

As the handover thresholds are determined, in accordance with some embodiments, based on present conditions that are applicable to UE 101 and/or to the specific handover source and/or targets, the handover thresholds may be able to be tightly tuned to optimize the performance of the wireless network with respect to UE 101 in any given handover scenario that is specific to UE 101 (e.g., based on UE attributes of the particular UE 101, based on historical performance metrics exhibited by handovers involving the potential handover source and targets within which UE 101 is in communication range, etc.). For example, the determination of handover thresholds based on specific handover scenarios for UE 101 may reduce or eliminate potential service disruptions that occur when performing handovers with the specific handover sources and/or targets, and/or may reduce or eliminate “ping ponging” between respective handover sources and targets.

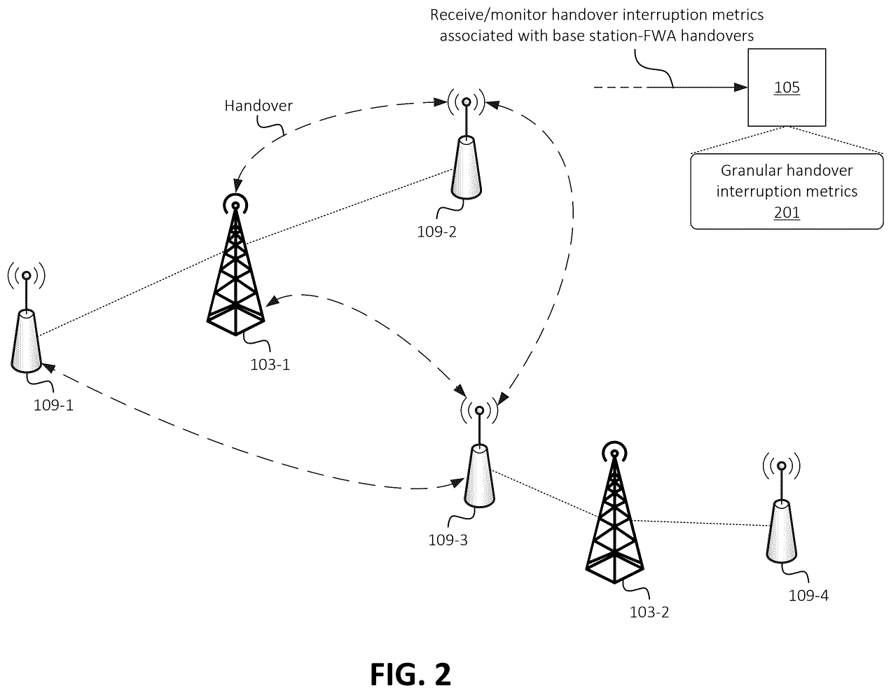

FIG. 2 illustrates an example of handovers for which SHS 105 may receive or maintain historical information (e.g., based on which SHS 105 may generate or refine handover models 107). In this example, handovers are illustrated between base station 103-1 and FWA device 109-2; between base station 103-1 and FWA device 109-3; and between FWA device 109-1 and FWA device 109-3. In practice, SHS 105 may receive or maintain historical information associated with handovers between additional or different wireless network access points in addition to or in lieu of the handovers shown in FIG. 2.

In some embodiments, SHS 105 may receive granular handover interruption metrics 201 that are associated with handovers between base stations 103 and FWA devices 109 and/or between FWA devices 109. Granular handover interruption metrics 201 may include performance metrics, Key Performance Indicators (“KPIs”), etc. that are associated with respective handovers between respective wireless network access points (e.g., between a given base station 103 and FWA device 109, between different FWA devices 109, etc.). Such performance metrics, KPIs, etc. may indicate or may result from a handover being performed of a given UE 101 from a source to a target (e.g., from base station 103-1 to FWA device 109-2, from FWA device 109-3 to base station 103-1, etc.), and may generally reflect a measure of service disruption exhibited by UE 101 undergoing such handover. For example, the performance metrics, KPIs, etc. may be measured, determined, etc. at a time window corresponding to a handover, such as from a particular amount of time prior to when a handover is performed to a particular amount of time after a handover is completed. In this sense, granular handover interruption metrics 201 may correspond to handover scenarios specifically, as opposed to indicating performance at some time that does not relate to any handovers being performed.

In examples described below, granular handover interruption metrics 201 are described in the context of latency and packet loss rate (“PLR”). Generally, for example, a higher measure of latency and/or PLR may indicate a greater disruption or degradation in wireless service for a given UE 101 performing a handover. In practice, additional or different performance metrics, KPIs, etc. may be included in granular handover interruption metrics 201.

In some embodiments, SHS 105 may receive granular handover interruption metrics 201 from UEs 101 that are the subject of such handovers (e.g., via an API, SDK, rApp, etc. implemented at such UEs 101), from respective base stations 103, from respective FWA devices 109, and/or from some other device or system. In some embodiments, SHS 105 may receive granular handover interruption metrics 201 via a SCEF, a NEF, or some other device or system that serves as an interface between core network elements and devices that are external to the core network. In some embodiments, for instance, base stations 103 and FWA devices 109 may be registered with the wireless network and/or may otherwise communicate with the wireless network, such that the wireless network is able to determine, monitor, etc. performance metrics, KPIs, and/or other information associated with base stations 103 and FWA devices 109.

In some embodiments, base stations 103 and/or FWA devices 109 may be operated by separate entities, such as separate Mobile Network Operators (“MNOs”) and/or other types of entities. In such embodiments, the respective entities that operate, provide, etc. respective base stations 103 and/or FWA devices 109 may implement one or more APIs, SDKs, etc. in order to facilitate the providing of granular handover metrics 201 to SHS 105, by such base stations 103 and/or FWA devices 109 associated with multiple different MNOs.

In some example scenarios, one or more base stations 103 and/or FWA devices 109 may not provide information (e.g., handover interruption metrics 201) to SHS 105. For example, a particular MNO that operates a given base station 103 and/or a given FWA device 109 may not configure such devices with an API, SDK, etc. that would facilitate the providing of handover interruption metrics 201, by base station 103 and/or a FWA device 109, to SHS 105. In some implementations, identifier information or other accessible information associated with base station 103 and/or FWA device 109 (e.g., a global cell identifier for a given base station 103, a Service Set Identifier (“SSID”) of a WLAN implemented by a given FWA device 109, a location of a particular UE 101 when in communication range of base station 103 and/or FWA device 109, etc.) may be provided to SHS 105 by one or more UEs 101. For example, when providing granular handover interruption metrics 201 associated with a given source and target, UE 101 may provide, to SHS 105, a global cell identifier, SSID, and/or other identifying information associated with the source and/or target. In this sense, SHS 105 may maintain or identify granular handover interruption metrics 201 for sources and/or targets that are not necessarily communicatively coupled to SHS 105.

Further, while FWA device 109 is discussed herein as an example of a device that provides connectivity (e.g., WLAN connectivity) via a RAT (e.g., a Wi-Fi RAT) other than a RAT implemented by base station 103 (e.g., an LTE RAT, a 5G RAT, etc.), similar concepts may be applicable for other types of APs that provide such connectivity to UEs 101. For example, similar concepts described herein may be applicable to handovers between base stations 103 and Wi-Fi routers or WLAN APs that do not implement FWA functionality (e.g., which do not connect to one or more base stations 103).

When receiving granular handover interruption metrics 201, SHS 105 may also receive or determine contextual, environmental, or other suitable information associated with respective handovers, such as a source of a handover, a target of a handover, an identifier and/or attribute information of a given UE 101 being handed over, temporal information (e.g., time of day, day of week, month, season, etc.), air quality information (e.g., particulate matter (“PM2.5”) information), or other information which may ultimately be relevant in generating or refining handover models 107. In some embodiments, SHS 105 may receive some or all of such information from one or more network elements (e.g., base stations 103 and/or FWA devices 109 that participate in UE handovers, from a network controller, etc.), from UEs 101, from one or more external application servers (e.g., an application server that provides a location-based weather or PM2.5 monitoring service), etc.

In some embodiments, granular handover interruption metrics 201 may be monitored, measured, etc. based on real-world handovers that are performed with respect to UEs 101, base stations 103, and/or FWA devices 109. In some embodiments, some or all of granular handover interruption metrics 201 may be monitored, measured, etc. based on simulations (e.g., in which UEs 101, base stations 103, and/or FWA devices 109 as well as communications between such devices are simulated).

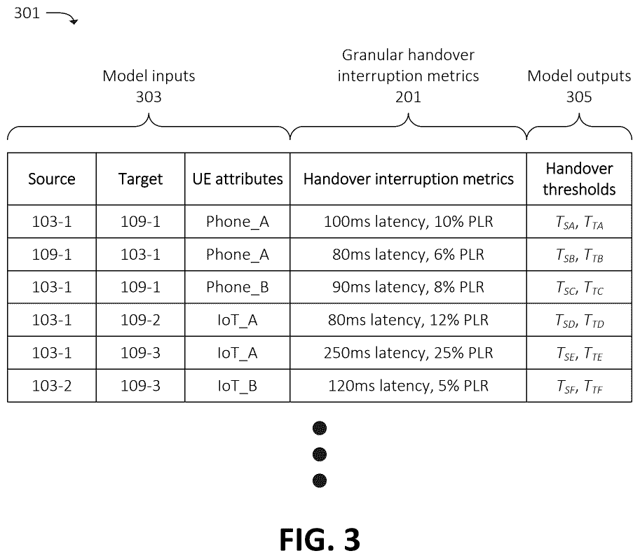

FIG. 3 illustrates an example data structure 301 that reflects the input and output of utilizing one or more handover models 107 (e.g., where such handover models 107 may be used to associate respective model inputs 303 with respective model outputs 305). As shown, a first set of model inputs 303 (e.g., base station 103-1 as a handover source, FWA device 109-1 as a handover target, and a first set of UE attributes (represented as “Phone_A”)) may be associated with a first set of model outputs 305. As noted above, UE attributes (e.g., as represented in data structure 301) may include attributes such as make and/or model of a given UE 101, device type (e.g., smartphone, IoT device, M2M device, etc.), operating system, battery life, and/or other information.

Model outputs 305 may include a set of handover thresholds, such as a first threshold (e.g., T_{SA}, where T_{S} refers to a threshold T associated with a handover source S) and a second threshold (e.g., T_{TA}, where T_{T} refers to a threshold T associated with a handover target T). As noted above, a respective set of handover thresholds may indicate conditions, criteria, thresholds, etc. based on which a given UE 101 should initiate, performance, etc. a handover from the source to the target. For example, as noted above, the first threshold T_{SA} may be a first signal strength or quality metric (or one or more values based on multiple signal or quality metrics), which is satisfied when signal strength or quality of a handover source is below the first threshold T_{SA}. As also noted above, the second threshold T_{TA} may be a second signal strength or quality metric (or one or more values based on multiple signal or quality metrics), which is satisfied when signal strength or quality of a handover target is above the second threshold T_{TA}.

Similarly, a second set of model inputs 303 (e.g., FWA device 109-1 as a handover source, base station 103-1 as a handover target, and the first set of UE attributes (e.g., “Phone_A”)) may be associated with a second set of model outputs 305 (e.g., a second set of handover thresholds T_{SB} and T_{TB}); a third set of model inputs 303 (e.g., base station 103-1 as a handover source, FWA device 109-1 as a handover target, and a second set of UE attributes (represented as “Phone_B”)) may be associated with a third set of model outputs 305 (e.g., a third set of handover thresholds T_{SC} and T_{TC}); and so on.

That is, handover models 107 may be granular in terms of handover sources and targets, particular UE attributes, and/or other information. For example, as shown, a first set of model outputs 305 (e.g., handover thresholds T_{SA} and T_{TA}) may be associated with a particular set of UE attributes (e.g., “Phone_A”) and handovers when base station 103-1 is the source and FWA device 109-1 is the target, and a second set of model outputs 305 (e.g., handover thresholds T_{SB} and T_{TB}) may be associated with the same set of UE attributes and handovers in the other direction (e.g., where FWA device 109-1 is the source and base station 103-1 is the target).

While examples are described here in the context of model inputs 303 including handover source and target information and UE attribute information, in practice, model inputs 303 may include additional or different information, such as temporal information, network congestion information (e.g., network congestion at the source and/or target), and/or other information. For example, one or more handover models 107 may include one set of handover thresholds that are applicable to base station 103-1 as a source, FWA device 109-1 as a target, a UE with a particular set of attributes, and a particular time of day (e.g., morning), while a different set of handover thresholds may be applicable with the same source, target, and UE attributes but at a different time of day (e.g., afternoon or evening).

SHS 105 may, for example, utilize AI/ML techniques or other suitable techniques to determine (e.g., based on granular handover interruption metrics 201) associations between respective model inputs 303 and model outputs 305. For example, SHS 105 may perform an iterative learning or training process, in which model outputs 305 (e.g., handover thresholds) are finetuned, refined, etc. to identify handover thresholds that optimize performance, QoS, etc. of the network and/or UEs 101 (e.g., to minimize service disruption to UEs 101, minimize “ping ponging” of UEs 101, etc.) in specific scenarios (e.g., handover scenarios between particular pairs of wireless network access points, such as between base stations 103 and FWA devices 109, and/or between different FWA devices 109).

Additionally, while examples are described herein in the context of particular handover sources and/or targets, similar concepts may apply to handover models 107 that are based on handover sources and/or targets with the same or similar respective sets of attributes or classifications. As one example, while data structure 301 (e.g., which reflects one or more handover models 107) includes information specifying a particular base station 103-1 as a handover source, similar concepts may apply when handover models 107 include a particular set of base station attributes, classifications, labels, etc. (e.g., base station type, location, RAT(s), etc.) as model input information specifying a handover source. Similarly, while data structure 301 includes information specifying a particular FWA device 109-1 as a handover target, similar concepts may apply when handover models 107 include a particular set of FWA device attributes, classifications, labels, etc. (e.g., FWA device type, location, RAT(s), etc.) as model input information specifying a handover target. Similarly, while data structure 301 shows UE attributes as example model input information, similar concepts may apply when handover models 107 specify particular UEs 101 or groups of UEs 101 as model input information (e.g., different handover thresholds may be applicable to UEs 101 having a particular identifier or being associated with a particular group or category).

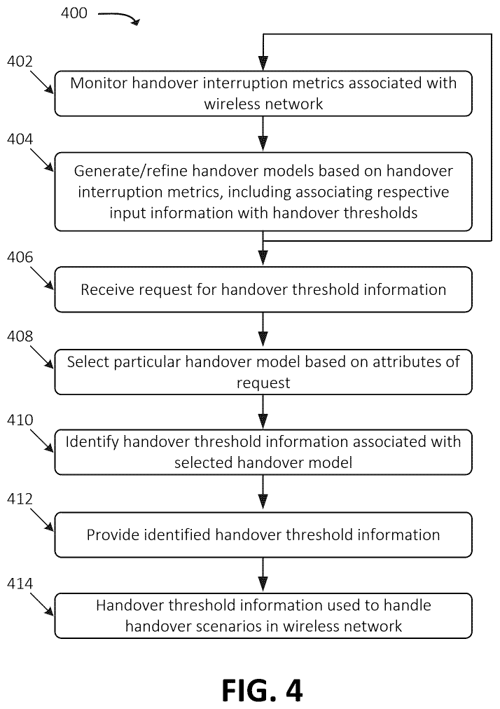

FIG. 4 illustrates an example process 400 for dynamically determining handover thresholds for a given handover scenario, in accordance with some embodiments. In some embodiments, some or all of process 400 may be performed by SHS 105. In some embodiments, one or more other devices may perform some or all of process 400 in concert with, and/or in lieu of, SHS 105.

As shown, process 400 may include monitoring (at 402) handover interruption metrics associated with a wireless network. For example, as discussed above, SHS 105 may monitor or receive granular handover interruption metrics 201 associated with handovers performed with respect to a wireless network, such as handovers between base stations 103 and FWA devices 109, and/or between FWA devices 109. As discussed above, base stations 103 may implement a licensed RAT, such as a 5G RAT or an LTE RAT, and FWA devices 109 may connect to base stations 103 via the RAT(s) implemented by base stations 103. Additionally, FWA devices 109 may implement another RAT, such as a Wi-Fi RAT, via which FWA devices 109 provide wireless connectivity (e.g., WAN connectivity, Internet connectivity, connectivity to a core network, etc.) to one or more UEs 101. As discussed above, granular handover interruption metrics 201 may include attribute and/or identification information associated with handover sources, handover targets, and UEs 101 involved in handovers. As further discussed above, granular handover interruption metrics 201 may additionally include other information, such as temporal information, network congestion information, location information, and/or other suitable information.

Process 400 may further include generating and/or refining (at 404) one or more handover models based on the handover interruption metrics. For example, as discussed above, SHS 105 and/or some other suitable device or system may utilize AI/ML techniques or other suitable techniques to generate one or more handover models 107 based on granular handover interruption metrics 201. For example, handover models 107 may associate input information (e.g., some or all of which may be based on granular handover interruption metrics 201) with respective output information. As discussed above, the input information may include identifiers of particular handover sources, attribute information associated with a set of handover sources, identifiers of particular handover targets, attribute information associated with a set of handover targets, identifiers of particular UEs 101, attribute information of a set of UEs 101, and/or other suitable information. As also discussed above, the output information may include handover thresholds, such as a first threshold that is satisfied when signal and/or quality metrics associated with a handover source are below the first threshold, and/or a second threshold that is satisfied when signal and/or quality metrics associated with a handover target are above the second threshold. As noted above, a scenario in which both thresholds are satisfied with respect to a particular UE 101 may indicate a scenario in which the particular UE 101 should be handed over from the source to the target.

Handover models 107 may, for example, be trained, refined, etc. based on granular handover interruption metrics 201, in order to optimize performance (e.g., minimize service disruption) of the network and/or of UEs 101 participating in handovers. For example, as discussed above, handover models 107 may be refined, optimized, etc. to minimize a quantity of handovers performed, minimize an incidence of periods of increased latency or PLR, and/or to minimize “ping ponging” between a source and a target.

Process 400 may additionally include receiving (at 406) a request for handover threshold information. For example, SHS 105 may receive the request from UE 101 based on UE 101 detecting that signal strength or quality between UE 101 and a network access point to which UE 101 is connected (e.g., a given base station 103 and/or a given FWA device 109) is degrading, has fallen below a threshold, etc. As another example, SHS 105 may automatically or proactively determine that handover threshold information should be provided to UE 101, such as on a periodic or other ongoing basis, or based on a request or indication from some other device or system.

Process 400 may also include selecting (at 408) a particular handover model based on attributes of the request. For example, SHS 105 may identify attributes of the request, such as an identifier of UE 101, attribute information of UE 101, an identifier of a handover source associated with UE 101 (e.g., a network access point to which UE 101 is currently connected), attributes of the handover source associated with UE 101, an identifier of one or more candidate handover targets associated with UE 101 (e.g., wireless network access points that are neighbors of the handover source), attributes of the one or more candidate handover targets, etc. In some embodiments, the identified attributes of the request may include other information, such as a current time of day, location information of UE 101, location information of the handover source and/or target, air quality information, congestion information associated with the handover source and/or target, and/or other suitable information. In some embodiments, the attributes of the request may be specified in the request itself. Additionally, or alternatively, SHS 105 may obtain attributes of the request from one or more other devices or systems, such as an HSS, a UDM, a UDR, an application server, etc.

SHS 105 may identify a particular handover model 107 with model inputs 303 that match the attributes of the request. In this context, “match” may refer to a similarity analysis or other suitable analysis, in which SHS 105 is able to determine that a particular set of model inputs 303 of a particular handover model 107 are the same as, or are similar to (e.g., with at least a threshold measure of similarity, or with a highest measure of similarity out of available handover models 107) the attributes of the request.

Process 400 may further include identifying (at 410) handover threshold information associated with the selected handover model. For example, SHS 105 may identify a set of handover thresholds indicated in the selected handover model 107, and providing (at 412) the identified handover threshold information in response to the request. For example, as discussed above, SHS 105 may provide the handover thresholds (e.g., model outputs 305 of the identified handover model 107) to UE 101 and/or some other suitable device or system. The handover threshold information may be used (at 414) to handle a handover scenario in a wireless network. For example, UE 101 may request, initiate, etc. a handover from a source (e.g., a base station 103 or FWA device 109 to which UE 101 is currently connected) to a candidate target when a measure of signal strength or quality between UE 101 and the source is below a first threshold, and/or when a measure of signal strength or quality between UE 101 and the candidate target is above a second threshold.

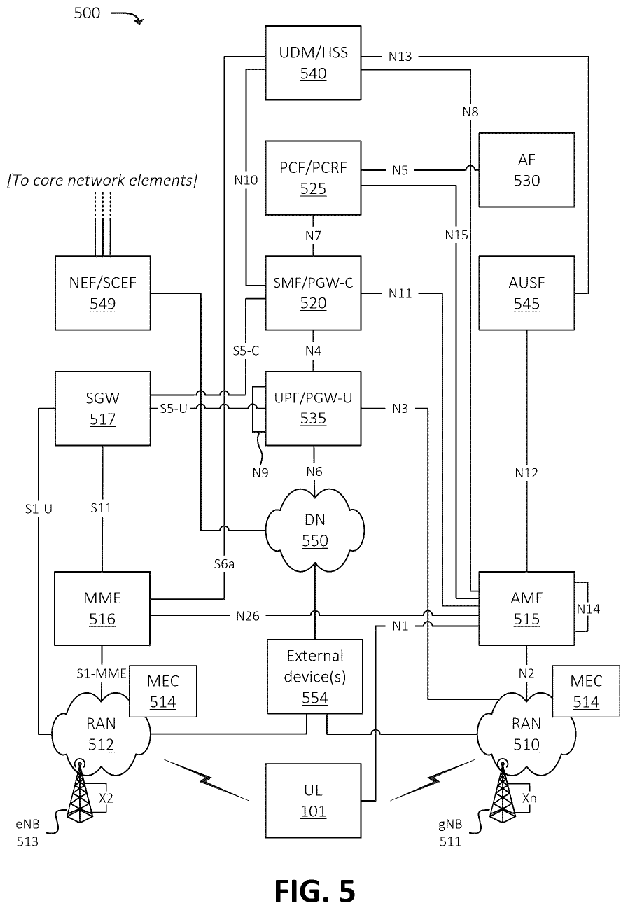

FIG. 5 illustrates an example environment 500, in which one or more embodiments may be implemented. In some embodiments, environment 500 may correspond to a Fifth Generation (“5G”) network, and/or may include elements of a 5G network. In some embodiments, environment 500 may correspond to a 5G Non-Standalone (“NSA”) architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 500 may represent or may include a 5G core (“5GC”). As shown, environment 500 may include UE 101, RAN 510 (which may include one or more gNBs 511), RAN 512 (which may include one or more eNBs 513), and various network functions such as Access and Mobility Management Function (“AMF”) 515, Mobility Management Entity (“MME”) 516, Serving Gateway (“SGW”) 517, Session Management Function (“SMF”)/Packet Data Network (“PDN”) Gateway (“PGW”)-Control plane function (“PGW-C”) 520, Policy Control Function (“PCF”)/Policy Charging and Rules Function (“PCRF”) 525, Application Function (“AF”) 530, User Plane Function (“UPF”)/PGW-User plane function (“PGW-U”) 535, UDM/HSS 540, Authentication Server Function (“AUSF”) 545, and Network Exposure Function (“NEF”)/Service Capability Exposure Function (“SCEF”) 549. Environment 500 may also include one or more networks, such as Data Network (“DN”) 550. Environment 500 may include one or more additional devices or systems communicatively coupled to one or more networks (e.g., DN 550), such as one or more external devices 554.

The example shown in FIG. 5 illustrates one instance of each network component or function (e.g., one instance of SMF/PGW-C 520, PCF/PCRF 525, UPF/PGW-U 535, UDM/HSS 540, and/or AUSF 545). In practice, environment 500 may include multiple instances of such components or functions. For example, in some embodiments, environment 500 may include multiple “slices” of a core network, where each slice includes a discrete and/or logical set of network functions (e.g., one slice may include a first instance of AMF 515, SMF/PGW-C 520, PCF/PCRF 525, and/or UPF/PGW-U 535, while another slice may include a second instance of AMF 515, SMF/PGW-C 520, PCF/PCRF 525, and/or UPF/PGW-U 535). The different slices may provide differentiated levels of service, such as service in accordance with different Quality of Service (“QoS”) parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Additionally, one or more elements of environment 500 may be implemented in a virtualized and/or containerized manner. For example, one or more of the elements of environment 500 may be implemented by one or more Virtualized Network Functions (“VNFs”), Cloud-Native Network Functions (“CNFs”), etc. In such embodiments, environment 500 may include, may implement, and/or may be communicatively coupled to an orchestration platform that provisions hardware resources, installs containers or applications, performs load balancing, and/or otherwise manages the deployment of such elements of environment 500. In some embodiments, such orchestration and/or management of such elements of environment 500 may be performed by, or in conjunction with, the open-source Kubernetes® application programming interface (“API”) or some other suitable virtualization, containerization, and/or orchestration system.

Elements of environment 500 may interconnect with each other and/or other devices via wired connections, wireless connections, or a combination of wired and wireless connections. Examples of interfaces or communication pathways between the elements of environment 500, as shown in FIG. 5, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 5, such as Service-Based Interfaces (“SBIs”), including an Namf interface, an Nudm interface, an Npcf interface, an Nupf interface, an Nnef interface, an Nsmf interface, and/or one or more other SBIs.

UE 101 may include a computation and communication device, such as a wireless mobile communication device that is capable of communicating with RAN 510, RAN 512, and/or DN 550. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a programmable logic controller or other industrial controller, an M2M device, or the like), or another type of mobile computation and communication device. In some embodiments, UE 101 may include, may implement, may be communicatively coupled to, and/or may otherwise be associated with a particular FWA device 109. UE 101 may send traffic to and/or receive traffic (e.g., user plane traffic) from DN 550 via RAN 510, RAN 512, and/or UPF/PGW-U 535.

RAN 510 may be, or may include, a 5G RAN that implements a 5G RAT and that includes one or more base stations (e.g., one or more gNBs 511), via which UE 101 may communicate with one or more other elements of environment 500. UE 101 may communicate with RAN 510 via an air interface (e.g., as provided by gNB 511). For instance, RAN 510 may receive traffic (e.g., user plane traffic such as voice call traffic, data traffic, messaging traffic, etc.) from UE 101 via the air interface, and may communicate the traffic to UPF/PGW-U 535 and/or one or more other devices or networks. Further, RAN 510 may receive signaling traffic, control plane traffic, etc. from UE 101 via the air interface, and may communicate such signaling traffic, control plane traffic, etc. to AMF 515 and/or one or more other devices or networks. Additionally, RAN 510 may receive traffic intended for UE 101 (e.g., from UPF/PGW-U 535, AMF 515, and/or one or more other devices or networks) and may communicate the traffic to UE 101 via the air interface. In some embodiments, base station 103 may be, may include, and/or may be implemented by one or more gNBs 511.

RAN 512 may be, or may include, an LTE RAN that implements an LTE RAT and that includes one or more base stations (e.g., one or more eNBs 513), via which UE 101 may communicate with one or more other elements of environment 500. UE 101 may communicate with RAN 512 via an air interface (e.g., as provided by eNB 513). For instance, RAN 512 may receive traffic (e.g., user plane traffic such as voice call traffic, data traffic, messaging traffic, signaling traffic, etc.) from UE 101 via the air interface, and may communicate the traffic to UPF/PGW-U 535 (e.g., via SGW 517) and/or one or more other devices or networks. Further, RAN 512 may receive signaling traffic, control plane traffic, etc. from UE 101 via the air interface, and may communicate such signaling traffic, control plane traffic, etc. to MME 516 and/or one or more other devices or networks. Additionally, RAN 512 may receive traffic intended for UE 101 (e.g., from UPF/PGW-U 535, MME 516, SGW 517, and/or one or more other devices or networks) and may communicate the traffic to UE 101 via the air interface. In some embodiments, base station 103 may be, may include, and/or may be implemented by one or more eNBs 513.

One or more RANs of environment 500 (e.g., RAN 510 and/or RAN 512) may include, may implement, and/or may otherwise be communicatively coupled to one or more edge computing devices, such as one or more Multi-Access/Mobile Edge Computing (“MEC”) devices (referred to sometimes herein simply as a “MECs”) 514. MECs 514 may be co-located with wireless network infrastructure equipment of RANs 510 and/or 512 (e.g., one or more gNBs 511 and/or one or more eNBs 513, respectively). Additionally, or alternatively, MECs 514 may otherwise be associated with geographical regions (e.g., coverage areas) of wireless network infrastructure equipment of RANs 510 and/or 512. In some embodiments, one or more MECs 514 may be implemented by the same set of hardware resources, the same set of devices, etc. that implement wireless network infrastructure equipment of RANs 510 and/or 512. In some embodiments, one or more MECs 514 may be implemented by different hardware resources, a different set of devices, etc. from hardware resources or devices that implement wireless network infrastructure equipment of RANs 510 and/or 512. In some embodiments, MECs 514 may be communicatively coupled to wireless network infrastructure equipment of RANs 510 and/or 512 (e.g., via a high-speed and/or low-latency link such as a physical wired interface, a high-speed and/or low-latency wireless interface, or some other suitable communication pathway).

MECs 514 may include hardware resources (e.g., configurable or provisionable hardware resources) that may be configured to provide services and/or otherwise process traffic to and/or from UE 101, via RAN 510 and/or 512. For example, RAN 510 and/or 512 may route some traffic from UE 101 (e.g., traffic associated with one or more particular services, applications, application types, etc.) to a respective MEC 514 instead of to core network elements of 500 (e.g., UPF/PGW-U 535). MEC 514 may accordingly provide services to UE 101 by processing such traffic, performing one or more computations based on the received traffic, and providing traffic to UE 101 via RAN 510 and/or 512. MEC 514 may include, and/or may implement, some or all of the functionality described above with respect to UPF/PGW-U 535, AF 530, one or more application servers, and/or one or more other devices, systems, VNFs, CNFs, etc. In this manner, ultra-low latency services may be provided to UE 101, as traffic does not need to traverse links (e.g., backhaul links) between RAN 510 and/or 512 and the core network.

AMF 515 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 510 and/or gNBs 511, and/or to perform other operations. In some embodiments, the 5G network may include multiple AMFs 515, which communicate with each other via the N14 interface (denoted in FIG. 5 by the line marked “N14” originating and terminating at AMF 515).

MME 516 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 512 and/or eNBs 513, and/or to perform other operations.

SGW 517 may include one or more devices, systems, VNFs, CNFs, etc., that aggregate traffic received from one or more eNBs 513 and send the aggregated traffic to an external network or device via UPF/PGW-U 535. Additionally, SGW 517 may aggregate traffic received from one or more UPF/PGW-Us 535 and may send the aggregated traffic to one or more eNBs 513. SGW 517 may operate as an anchor for the user plane during inter-eNB handovers and as an anchor for mobility between different telecommunication networks or RANs (e.g., RANs 510 and 512).

SMF/PGW-C 520 may include one or more devices, systems, VNFs, CNFs, etc., that gather, process, store, and/or provide information in a manner described herein. SMF/PGW-C 520 may, for example, facilitate the establishment of communication sessions on behalf of UE 101. In some embodiments, the establishment of communications sessions may be performed in accordance with one or more policies provided by PCF/PCRF 525.

PCF/PCRF 525 may include one or more devices, systems, VNFs, CNFs, etc., that aggregate information to and from the 5G network and/or other sources. PCF/PCRF 525 may receive information regarding policies and/or subscriptions from one or more sources, such as subscriber databases and/or from one or more users (such as, for example, an administrator associated with PCF/PCRF 525).

AF 530 may include one or more devices, systems, VNFs, CNFs, etc., that receive, store, and/or provide information that may be used in determining parameters (e.g., quality of service parameters, charging parameters, or the like) for certain applications.

UPF/PGW-U 535 may include one or more devices, systems, VNFs, CNFs, etc., that receive, store, and/or provide data (e.g., user plane data). For example, UPF/PGW-U 535 may receive user plane data (e.g., voice call traffic, data traffic, etc.), destined for UE 101, from DN 550, and may forward the user plane data toward UE 101 (e.g., via RAN 510, SMF/PGW-C 520, and/or one or more other devices). In some embodiments, multiple instances of UPF/PGW-U 535 may be deployed (e.g., in different geographical locations), and the delivery of content to UE 101 may be coordinated via the N9 interface (e.g., as denoted in FIG. 5 by the line marked “N9” originating and terminating at UPF/PGW-U 535). Similarly, UPF/PGW-U 535 may receive traffic from UE 101 (e.g., via RAN 510, RAN 512, SMF/PGW-C 520, and/or one or more other devices), and may forward the traffic toward DN 550. In some embodiments, UPF/PGW-U 535 may communicate (e.g., via the N4 interface) with SMF/PGW-C 520, regarding user plane data processed by UPF/PGW-U 535.

UDM/HSS 540 and AUSF 545 may include one or more devices, systems, VNFs, CNFs, etc., that manage, update, and/or store, in one or more memory devices associated with AUSF 545 and/or UDM/HSS 540, profile information associated with a subscriber. In some embodiments, UDM/HSS 540 may include, may implement, may be communicatively coupled to, and/or may otherwise be associated with some other type of repository or database, such as a UDR. AUSF 545 and/or UDM/HSS 540 may perform authentication, authorization, and/or accounting operations associated with one or more UEs 101 and/or one or more communication sessions associated with one or more UEs 101.

DN 550 may include one or more wired and/or wireless networks. For example, DN 550 may include an Internet Protocol (“IP”)-based PDN, a wide area network (“WAN”) such as the Internet, a private enterprise network, and/or one or more other networks. UE 101 may communicate, through DN 550, with data servers, other UEs 101, and/or to other servers or applications that are coupled to DN 550. DN 550 may be connected to one or more other networks, such as a public switched telephone network (“PSTN”), a public land mobile network (“PLMN”), and/or another network. DN 550 may be connected to one or more devices, such as content providers, applications, web servers, and/or other devices, with which UE 101 may communicate.

External devices 554 may include one or more devices or systems that communicate with UE 101 via DN 550 and one or more elements of 500 (e.g., via UPF/PGW-U 535). In some embodiments, external devices 554 may include, may implement, and/or may otherwise be associated with SHS 105. External devices 554 may include, for example, one or more application servers, content provider systems, web servers, or the like. External devices 554 may, for example, implement “server-side” applications that communicate with “client-side” applications executed by UE 101. External devices 554 may provide services to UE 101 such as gaming services, videoconferencing services, messaging services, email services, web services, and/or other types of services. Operations described above with respect to a given external device 554 (e.g., in accordance with some embodiments) may be performed by a single device, by a cloud computing system, by one or more devices that implement a virtualized or containerized environment, a collection of devices, etc.

In some embodiments, external devices 554 may communicate with one or more elements of environment 500 (e.g., core network elements) via NEF/SCEF 549. NEF/SCEF 549 include one or more devices, systems, VNFs, CNFs, etc. that provide access to information, APIs, and/or other operations or mechanisms of one or more core network elements to devices or systems that are external to the core network (e.g., to external device 554 via DN 550). NEF/SCEF 549 may maintain authorization and/or authentication information associated with such external devices or systems, such that NEF/SCEF 549 is able to provide information, that is authorized to be provided, to the external devices or systems. For example, a given external device 554 may request particular information associated with one or more core network elements. NEF/SCEF 549 may authenticate the request and/or otherwise verify that external device 554 is authorized to receive the information, and may request, obtain, or otherwise receive the information from the one or more core network elements. In some embodiments, NEF/SCEF 549 may include, may implement, may be implemented by, may be communicatively coupled to, and/or may otherwise be associated with a Security Edge Protection Proxy (“SEPP”), which may perform some or all of the functions discussed above. External device 554 may, in some situations, subscribe to particular types of requested information provided by the one or more core network elements, and the one or more core network elements may provide (e.g., “push”) the requested information to NEF/SCEF 549 (e.g., in a periodic or otherwise ongoing basis).

In some embodiments, external devices 554 may communicate with one or more elements of RAN 510 and/or 512 via an API or other suitable interface. For example, a given external device 554 may provide instructions, requests, etc. to RAN 510 and/or 512 to provide one or more services via one or more respective MECs 514. In some embodiments, such instructions, requests, etc. may include QoS parameters, Service Level Agreements (“SLAs”), etc. (e.g., maximum latency thresholds, minimum throughput thresholds, etc.) associated with the services.

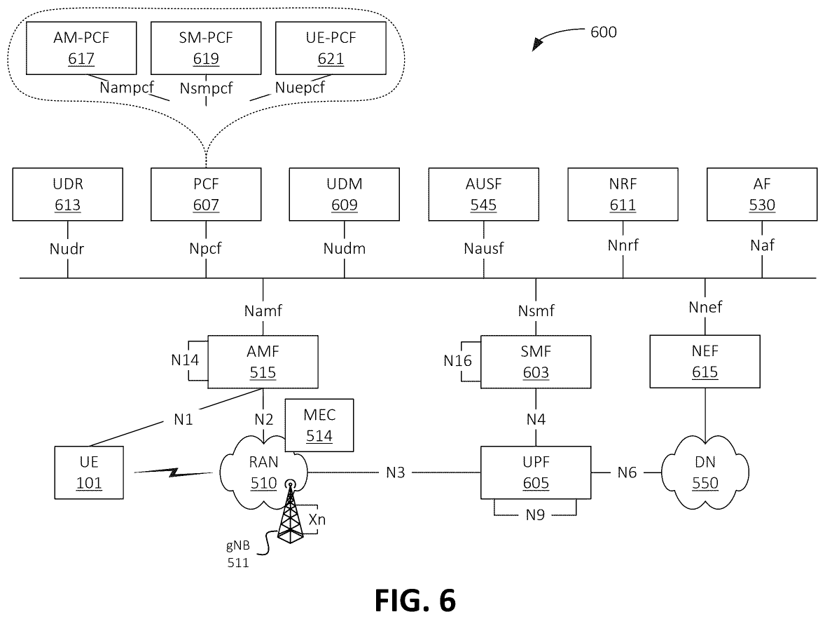

FIG. 6 illustrates another example environment 600, in which one or more embodiments may be implemented. In some embodiments, environment 600 may correspond to a 5G network, and/or may include elements of a 5G network. In some embodiments, environment 600 may correspond to a 5G SA architecture. In some embodiments, environment 600 may include a 5GC, in which 5GC network elements perform one or more operations described herein.

As shown, environment 600 may include UE 101, RAN 510 (which may include one or more gNBs 511 or other types of wireless network infrastructure) and various network functions, which may be implemented as VNFs, CNFs, etc. Such network functions may include AMF 515, SMF 603, UPF 605, PCF 607, UDM 609, AUSF 545, Network Repository Function (“NRF”) 611, AF 530, UDR 613, and NEF 615. Environment 600 may also include or may be communicatively coupled to one or more networks, such as DN 550.

The example shown in FIG. 6 illustrates one instance of each network component or function (e.g., one instance of SMF 603, UPF 605, PCF 607, UDM 609, AUSF 545, etc.). In practice, environment 600 may include multiple instances of such components or functions. For example, in some embodiments, environment 600 may include multiple “slices” of a core network, where each slice includes a discrete and/or logical set of network functions (e.g., one slice may include a first instance of SMF 603, PCF 607, UPF 605, etc., while another slice may include a second instance of SMF 603, PCF 607, UPF 605, etc.). Additionally, or alternatively, one or more of the network functions of environment 600 may implement multiple network slices. The different slices may provide differentiated levels of service, such as service in accordance with different QoS parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Elements of environment 600 may interconnect with each other and/or other devices via wired connections, wireless connections, or a combination of wired and wireless connections. Examples of interfaces or communication pathways between the elements of environment 600, as shown in FIG. 6, may include interfaces shown in FIG. 6 and/or one or more interfaces not explicitly shown in FIG. 6. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 600 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 515), an Nudm interface (e.g., indicating communications to be routed to UDM 609), an Npcf interface, an Nupf interface, an Nnef interface, an Nsmf interface, an Nnrf interface, an Nudr interface, an Naf interface, and/or one or more other SBIs.

UPF 605 may include one or more devices, systems, VNFs, CNFs, etc., that receive, route, process, and/or forward traffic (e.g., user plane traffic). As discussed above, UPF 605 may communicate with UE 101 via one or more communication sessions, such as PDU sessions. Such PDU sessions may be associated with a particular network slice or other suitable QoS parameters, as noted above. UPF 605 may receive downlink user plane traffic (e.g., voice call traffic, data traffic, etc. destined for UE 101) from DN 550, and may forward the downlink user plane traffic toward UE 101 (e.g., via RAN 510). In some embodiments, multiple UPFs 605 may be deployed (e.g., in different geographical locations), and the delivery of content to UE 101 may be coordinated via the N9 interface. Similarly, UPF 605 may receive uplink traffic from UE 101 (e.g., via RAN 510), and may forward the traffic toward DN 550. In some embodiments, UPF 605 may implement, may be implemented by, may be communicatively coupled to, and/or may otherwise be associated with UPF/PGW-U 535. In some embodiments, UPF 605 may communicate (e.g., via the N4 interface) with SMF 603, regarding user plane data processed by UPF 605 (e.g., to provide analytics or reporting information, to receive policy and/or authorization information, etc.).

PCF 607 may include one or more devices, systems, VNFs, CNFs, etc., that aggregate, derive, generate, etc. policy information associated with the 5GC and/or UEs 101 that communicate via the 5GC and/or RAN 510. PCF 607 may receive information regarding policies and/or subscriptions from one or more sources, such as subscriber databases (e.g., UDM 609, UDR 613, etc.), and/or from one or more users such as, for example, an administrator associated with PCF 607. In some embodiments, the functionality of PCF 607 may be split into multiple network functions or subsystems, such as access and mobility PCF (“AM-PCF”) 617, session management PCF (“SM-PCF”) 619, UE PCF (“UE-PCF”) 621, and so on. Such different “split” PCFs may be associated with respective SBIs (e.g., AM-PCF 617 may be associated with an Nampcf SBI, SM-PCF 619 may be associated with an Nsmpcf SBI, UE-PCF 621 may be associated with an Nuepcf SBI, and so on) via which other network functions may communicate with the split PCFs. The split PCFs may maintain information regarding policies associated with different devices, systems, and/or network functions.

NRF 611 may include one or more devices, systems, VNFs, CNFs, etc. that maintain routing and/or network topology information associated with the 5GC. For example, NRF 611 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 613 may include one or more devices, systems, VNFs, CNFs, etc. that provide user and/or subscriber information, based on which PCF 607 and/or other elements of environment 600 may determine access policies, QoS policies, charging policies, or the like. In some embodiments, UDR 613 may receive such information from UDM 609 and/or one or more other sources.

NEF 615 include one or more devices, systems, VNFs, CNFs, etc. that provide access to information, APIs, and/or other operations or mechanisms of the 5GC to devices or systems that are external to the 5GC. NEF 615 may maintain authorization and/or authentication information associated with such external devices or systems, such that NEF 615 is able to provide information, that is authorized to be provided, to the external devices or systems. Such information may be received from other network functions of the 5GC (e.g., as authorized by an administrator or other suitable entity associated with the 5GC), such as SMF 603, UPF 605, a charging function (“CHF”) of the 5GC, and/or other suitable network function. NEF 615 may communicate with external devices or systems (e.g., external devices 554) via DN 550 and/or other suitable communication pathways.

While environment 600 is described in the context of a 5GC, as noted above, environment 600 may, in some embodiments, include or implement one or more other types of core networks. For example, in some embodiments, environment 600 may be or may include a converged packet core, in which one or more elements may perform some or all of the functionality of one or more 5GC network functions and/or one or more EPC network functions. For example, in some embodiments, AMF 515 may include, may implement, may be implemented by, and/or may otherwise be associated with MME 516; SMF 603 may include, may implement, may be implemented by, and/or may otherwise be associated with SGW 517; PCF 607 may include, may implement, may be implemented by, and/or may otherwise be associated with a PCRF (e.g., PCF/PCRF 525); NEF 615 may include, may implement, may be implemented by, and/or may otherwise be associated with a SCEF (e.g., NEF/SCEF 549); and so on.

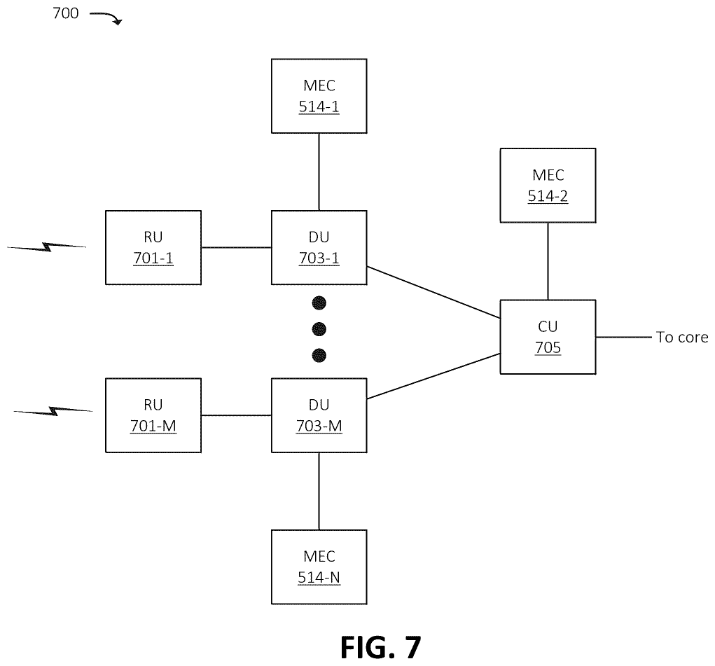

FIG. 7 illustrates an example RAN environment 700, which may be included in and/or implemented by one or more RANs (e.g., RAN 510 or some other RAN). In some embodiments, a particular RAN 510 may include one RAN environment 700. In some embodiments, a particular RAN 510 may include multiple RAN environments 700. In some embodiments, RAN environment 700 may correspond to a particular gNB 511 of RAN 510. In some embodiments, RAN environment 700 may correspond to multiple gNBs 511. In some embodiments, RAN environment 700 may correspond to one or more other types of base stations of one or more other types of RANs. As shown, RAN environment 700 may include Central Unit (“CU”) 705, one or more Distributed Units (“DUs”) 703-1 through 703-M (referred to individually as “DU 703,” or collectively as “DUs 703”), and one or more Radio Units (“RUs”) 701-1 through 701-M (referred to individually as “RU 701,” or collectively as “RUs 701”).

CU 705 may communicate with a core of a wireless network (e.g., may communicate with one or more of the devices or systems described above with respect to FIG. 6, such as AMF 515 and/or UPF 605) and/or some other device or system such as MEC 514. In the uplink direction (e.g., for traffic from UEs 101 to a core network), CU 705 may aggregate traffic from DUs 703, and forward the aggregated traffic to the core network. In some embodiments, CU 705 may receive traffic according to a given protocol (e.g., Radio Link Control (“RLC”) traffic) from DUs 703, and may perform higher-layer processing (e.g., may aggregate/process RLC packets and generate Packet Data Convergence Protocol (“PDCP”) packets based on the RLC packets) on the traffic received from DUs 703.

CU 705 may receive downlink traffic (e.g., traffic from the core network, traffic from a given MEC 514, etc.) for a particular UE 101, and may determine which DU(s) 703 should receive the downlink traffic. DU 703 may include one or more devices that transmit traffic between a core network (e.g., via CU 705) and UE 101 (e.g., via a respective RU 701). DU 703 may, for example, receive traffic from RU 701 at a first layer (e.g., physical (“PHY”) layer traffic, or lower PHY layer traffic), and may process/aggregate the traffic to a second layer (e.g., upper PHY and/or RLC). DU 703 may receive traffic from CU 705 at the second layer, may process the traffic to the first layer, and provide the processed traffic to a respective RU 701 for transmission to UE 101.

RU 701 may include hardware circuitry (e.g., one or more RF transceivers, antennas, radios, and/or other suitable hardware) to communicate wirelessly (e.g., via an RF interface) with one or more UEs 101, one or more other DUs 703 (e.g., via RUs 701 associated with DUs 703), and/or any other suitable type of device. In the uplink direction, RU 701 may receive traffic from UE 101 and/or another DU 703 via the RF interface and may provide the traffic to DU 703. In the downlink direction, RU 701 may receive traffic from DU 703, and may provide the traffic to UE 101 and/or another DU 703.

One or more elements of RAN environment 700 may, in some embodiments, be communicatively coupled to one or more MECs 514. For example, DU 703-1 may be communicatively coupled to MEC 514-1, DU 703-M may be communicatively coupled to MEC 514-N, CU 705 may be communicatively coupled to MEC 514-2, and so on. MECs 514 may include hardware resources (e.g., configurable or provisionable hardware resources) that may be configured to provide services and/or otherwise process traffic to and/or from UE 101, via a respective RU 701.

For example, DU 703-1 may route some traffic, from UE 101, to MEC 514-1 instead of to a core network via CU 705. MEC 514-1 may process the traffic, perform one or more computations based on the received traffic, and may provide traffic to UE 101 via RU 701-1. As discussed above, MEC 514 may include, and/or may implement, some or all of the functionality described above with respect to UPF 605, AF 530, and/or one or more other devices, systems, VNFs, CNFs, etc. In this manner, ultra-low latency services may be provided to UE 101, as traffic does not need to traverse DU 703, CU 705, links between DU 703 and CU 705, and an intervening backhaul network between RAN environment 700 and the core network.

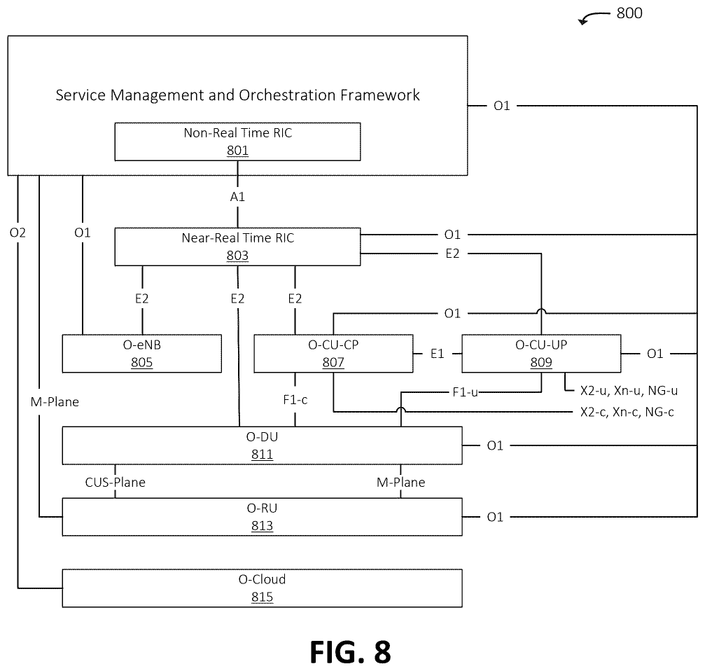

FIG. 8 illustrates an example O-RAN environment 800, which may correspond to RAN 510, RAN 512, and/or RAN environment 700. For example, RAN 510, RAN 512, and/or RAN environment 700 may include one or more instances of O-RAN environment 800, and/or one or more instances of O-RAN environment 800 may implement RAN 510, RAN 512, RAN environment 700, and/or some portion thereof. As shown, O-RAN environment 800 may include Non-Real Time Radio Intelligent Controller (“RIC”) 801, Near-Real Time RIC 803, O-eNB 805, O-CU-Control Plane (“O-CU-CP”) 807, O-CU-User Plane (“O-CU-UP”) 809, O-DU 811, O-RU 813, and O-Cloud 815. In some embodiments, O-RAN environment 800 may include additional, fewer, different, and/or differently arranged components or interfaces.

In some embodiments, some or all of the elements of O-RAN environment 800 may be implemented by one or more configurable or provisionable resources, such as virtual machines, cloud computing systems, physical servers, and/or other types of configurable or provisionable resources. In some embodiments, some or all of O-RAN environment 800 may be implemented by, and/or communicatively coupled to, one or more MECs 514.

Non-Real Time RIC 801 and Near-Real Time RIC 803 may receive performance information (and/or other types of information) from one or more sources, and may configure other elements of O-RAN environment 800 based on such performance or other information. For example, Near-Real Time RIC 803 may receive performance information, via one or more E2 interfaces, from O-eNB 805, O-CU-CP 807, and/or O-CU-UP 809, and may modify parameters associated with O-eNB 805, O-CU-CP 807, and/or O-CU-UP 809 based on such performance information. Similarly, Non-Real Time RIC 801 may receive performance information associated with O-eNB 805, O-CU-CP 807, O-CU-UP 809, and/or one or more other elements of O-RAN environment 800 and may utilize machine learning and/or other higher level computing or processing to determine modifications to the configuration of O-eNB 805, O-CU-CP 807, O-CU-UP 809, and/or other elements of O-RAN environment 800. In some embodiments, Non-Real Time RIC 801 may generate machine learning models (e.g., handover models 107) based on performance information associated with O-RAN environment 800 or other sources, such as granular handover interruption metrics 201 and/or other suitable information, and may provide such models to Near-Real Time RIC 803 for implementation. In some embodiments, Non-Real Time RIC 801 and/or Near-Real Time RIC 803 may perform some or all of the operations described above with respect to SHS 105.

O-eNB 805 may perform functions similar to those described above with respect to gNB 511 and/or eNB 513. For example, O-eNB 805 may facilitate wireless communications between UE 101 and a core network. O-CU-CP 807 may perform control plane signaling to coordinate the aggregation and/or distribution of traffic via one or more DUs 703, which may include and/or be implemented by one or more O-DUs 811, and O-CU-UP 809 may perform the aggregation and/or distribution of traffic via such DUs 703 (e.g., O-DUs 811). O-DU 811 may be communicatively coupled to one or more RUs 701, which may include and/or may be implemented by one or more O-RUs 813. In some embodiments, O-Cloud 815 may include or be implemented by one or more MECs 514, which may provide services, and may be communicatively coupled, to O-CU-CP 807, O-CU-UP 809, O-DU 811, and/or O-RU 813 (e.g., via an O1 and/or O2 interface).

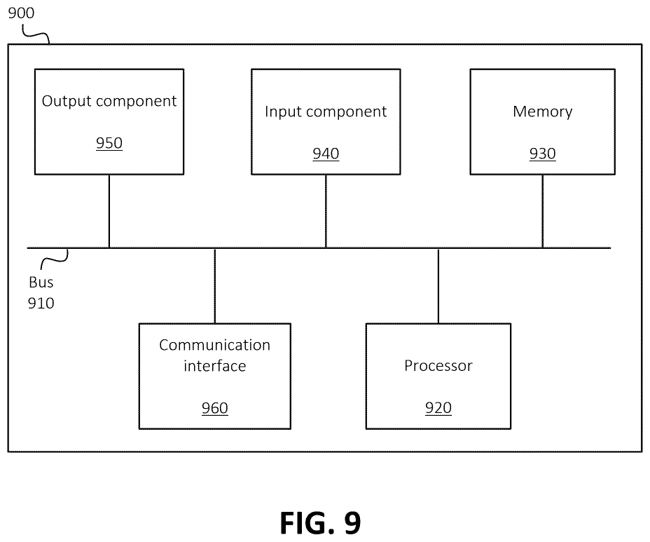

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems (e.g., via RAN 510, RAN 512, DN 550, etc.). For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 900 may include more than one communication interface 960. For instance, device 900 may include an optical interface, a wireless interface, an Ethernet interface, and/or one or more other interfaces.

Device 900 may perform certain operations relating to one or more processes described above. Device 900 may perform these operations in response to processor 920 executing instructions, such as software instructions, processor-executable instructions, etc. stored in a computer-readable medium, such as memory 930. A computer-readable medium may be defined as a non-transitory memory device. A memory device may include space within a single physical memory device or spread across multiple physical memory devices. The instructions may be read into memory 930 from another computer-readable medium or from another device. The instructions stored in memory 930 may be processor-executable instructions that cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-4), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed IS:

1. A device, comprising:
one or more processors configured to:
maintain one or more models that are generated based on handover interruption metrics associated with handovers associated with one or more User Equipment (“UEs”), wherein the one or more models include respective handover threshold information;
receive a request for handover threshold information;
identify, based on the request and further based on the one or more models, particular handover threshold information; and
output, in response to the request, the particular handover threshold information, wherein a particular UE uses the set of particular set of handover threshold information to determine whether to perform a handover from a particular handover source to a particular candidate handover target.

2. The device of claim 1, wherein the particular handover source includes a particular base station of a wireless network, and wherein the particular candidate handover target includes a Fixed Wireless Access (“FWA”) device that is communicatively coupled to at least one of:
the particular base station, or
a different base station of the wireless network.

3. The device of claim 1, wherein the particular handover target includes a particular base station of a wireless network, and wherein the particular candidate handover source includes a Fixed Wireless Access (“FWA”) device that is communicatively coupled to at least one of:
the particular base station, or
a different base station of the wireless network.

4. The device of claim 1, wherein the particular handover source implements a first radio access technology (“RAT”), and wherein the particular handover target implements a second RAT.

5. The device of claim 1, wherein the one or more models each associate a respective set of inputs with a respective set of outputs,
wherein the set of inputs associated with a particular model include:
a particular set of handover source information,
a particular set of handover target information, and
a particular set of UE information, and
wherein the set of outputs associated with the particular model include a particular set of handover thresholds.

6. The device of claim 5, wherein the one or more models are generated based on handover interruption metrics associated with a plurality of handovers performed with respect to a plurality of UEs that are associated with the particular set of UE information, wherein the plurality of handovers are handovers from a respective handover source that is associated with the particular set of handover source information to a respective handover target that is associated with the particular set of handover target information.

7. The device of claim 1, wherein the set of handover thresholds includes:
a first signal strength or quality threshold that is satisfied when a first measure of signal strength or quality between the particular UE and the particular handover source is below the first signal strength or quality threshold, and
a second signal strength or quality threshold that is satisfied when a second measure of signal strength or quality between the particular UE and the particular handover target is above the second signal strength or quality threshold.

8. A non-transitory computer-readable medium, storing a plurality of processor-executable instructions to:
maintain one or more models that are generated based on handover interruption metrics associated with handovers associated with one or more User Equipment (“UEs”), wherein the one or more models include respective handover threshold information;
receive a request for handover threshold information;
identify, based on the request and further based on the one or more models, particular handover threshold information; and
output, in response to the request, the particular handover threshold information, wherein a particular UE uses the set of particular set of handover threshold information to determine whether to perform a handover from a particular handover source to a particular candidate handover target.

9. The non-transitory computer-readable medium of claim 8, wherein the particular handover source includes a particular base station of a wireless network, and wherein the particular candidate handover target includes a Fixed Wireless Access (“FWA”) device that is communicatively coupled to at least one of:
the particular base station, or
a different base station of the wireless network.

10. The non-transitory computer-readable medium of claim 8, wherein the particular handover target includes a particular base station of a wireless network, and wherein the particular candidate handover source includes a Fixed Wireless Access (“FWA”) device that is communicatively coupled to at least one of:
the particular base station, or
a different base station of the wireless network.

11. The non-transitory computer-readable medium of claim 8, wherein the particular handover source implements a first radio access technology (“RAT”), and wherein the particular handover target implements a second RAT.

12. The non-transitory computer-readable medium of claim 8, wherein the one or more models each associate a respective set of inputs with a respective set of outputs,
wherein the set of inputs associated with a particular model include:
a particular set of handover source information,
a particular set of handover target information, and
a particular set of UE information, and
wherein the set of outputs associated with the particular model include a particular set of handover thresholds.

13. The non-transitory computer-readable medium of claim 12, wherein the one or more models are generated based on handover interruption metrics associated with a plurality of handovers performed with respect to a plurality of UEs that are associated with the particular set of UE information, wherein the plurality of handovers are handovers from a respective handover source that is associated with the particular set of handover source information to a respective handover target that is associated with the particular set of handover target information.

14. The non-transitory computer-readable medium of claim 8, wherein the set of handover thresholds includes:
a first signal strength or quality threshold that is satisfied when a first measure of signal strength or quality between the particular UE and the particular handover source is below the first signal strength or quality threshold, and
a second signal strength or quality threshold that is satisfied when a second measure of signal strength or quality between the particular UE and the particular handover target is above the second signal strength or quality threshold.

15. A method, comprising:
maintaining one or more models that are generated based on handover interruption metrics associated with handovers associated with one or more User Equipment (“UEs”), wherein the one or more models include respective handover threshold information;
receiving a request for handover threshold information;
identifying, based on the request and further based on the one or more models, particular handover threshold information; and
outputting, in response to the request, the particular handover threshold information, wherein a particular UE uses the set of particular set of handover threshold information to determine whether to perform a handover from a particular handover source to a particular candidate handover target.

16. The method of claim 15, wherein the particular handover source includes a particular base station of a wireless network, and wherein the particular candidate handover target includes a Fixed Wireless Access (“FWA”) device that is communicatively coupled to at least one of:
the particular base station, or
a different base station of the wireless network.

17. The method of claim 15, wherein the particular handover target includes a particular base station of a wireless network, and wherein the particular candidate handover source includes a Fixed Wireless Access (“FWA”) device that is communicatively coupled to at least one of:
the particular base station, or
a different base station of the wireless network.

18. The method of claim 15, wherein the particular handover source implements a first radio access technology (“RAT”), and wherein the particular handover target implements a second RAT.

19. The method of claim 18, wherein the one or more models each associate a respective set of inputs with a respective set of outputs,
wherein the set of inputs associated with a particular model include:
a particular set of handover source information,
a particular set of handover target information, and
a particular set of UE information, and
wherein the set of outputs associated with the particular model include a particular set of handover thresholds,
wherein the one or more models are generated based on handover interruption metrics associated with a plurality of handovers performed with respect to a plurality of UEs that are associated with the particular set of UE information, wherein the plurality of handovers are handovers from a respective handover source that is associated with the particular set of handover source information to a respective handover target that is associated with the particular set of handover target information.

20. The method of claim 15, wherein the set of handover thresholds includes:
a first signal strength or quality threshold that is satisfied when a first measure of signal strength or quality between the particular UE and the particular handover source is below the first signal strength or quality threshold, and
a second signal strength or quality threshold that is satisfied when a second measure of signal strength or quality between the particular UE and the particular handover target is above the second signal strength or quality threshold.
